(19) United States
(12) Patent Application Publication
(10) Pub. No.: US 2002/0136028 A1
(43) Pub. Date: Sep. 26, 2002

(54) LIGHTING APPARATUS TO PROVIDE CONCENTRATE ILLUMINATION TO AN END OF A FIBER OPTIC BUNDLE

(75) Inventor: Eric A. Smith, Petersburg, FL (US)

Correspondence Address: Anthony S. Zummer, 39 S. LaSalle Street, Suite 1222, Cicago, IL, 60603, US

(73) Assignee: Juno Manufacturing, Inc.

(21) Appl. No.: 09/800,946

(22) Filed: Mar. 7, 2001

(51) Int. Cl. F21V 29/00

(52) U.S. Cl. 362/580; 362/583; 362/581; 362/345; 362/373

(57) ABSTRACT

A lighting apparatus to provide concentrated illumination to an end of a fiber optic bundle to produce useable light includes a light source emitting visible light and heat, including infrared radiation and ultra-violet radiation. A reflector is positioned adjacent to the light source to direct light from the light source toward an end of the fiber optic bundle. A light and heat trap is positioned adjacent to the reflector for trapping heat and redirecting stray light in combination with the reflector toward the end of the fiber optic bundle. A hot mirror is positioned between the light and heat trap and the end of the fiber optic bundle to allow visible light to be transmitted through the mirror and to reflect infrared and ultra-violet radiation to prevent substantially all of the emitted infrared and ultra-violet radiation from reaching the fiber optic bundle.

### BACKGROUND OF THE INVENTION

In certain applications utilizing fiber optic bundles, it is desirable to produce a sideglow or endglow from the bundle. Typically a light source is positioned adjacent to the end of a fiber optic bundle, which generates a light. One of the problems attendant an apparatus to produce sideglow is that if the light source is too close to the end of the fiber optic bundle, it will adversely effect the fibers in the bundle. Furthermore, a typical light source produces ultra-violet radiation which adversely effects the fiber optic bundle. It is desirable to place the light source as close to the end of the fiber optic bundle as possible inasmuch as the light decays as the square of the distance from the light source to the fiber optic bundle. If the light source can be positioned closer to the end of the fiber optic bundle, the light transmission is improved by the square of the distance.

Typically, reflectors are used in conjunction with the light source to focus the light from the light source to the end of the fiber optic bundle. However, there is a certain part of the light emanating from the light source which is stray light and the loss of that light decreases the efficiency of the lighting apparatus.

### SUMMARY OF THE INVENTION

The present invention is an improved apparatus for providing concentrated illumination to the end of a fiber optic bundle. The present apparatus includes a housing with an electronic ballast mounted in the housing. A lamp is connected to the electronic ballast to produce a range of energy including visible light and heat including infrared and ultra-violet radiation. A reflector is positioned adjacent to the lamp to direct the light and heat, including the infrared and ultra-violet radiation toward the end of a fiber optic bundle to generate useable light. A conical light and heat trap is positioned adjacent to the reflector retaining heat and redirecting stray light in combination with the reflector. A hot mirror is positioned between the lamp and the end of the fiber optic bundle to reflect infrared and ultra-violet radiation to prevent substantially all of the infrared and ultra-violet radiation from reaching the fiber optic bundle, but allow visible light to be transmitted through the mirror toward the fiber optic bundle. A fan moves air past the reflector and through the light and heat trap to remove heat from the reflector and the light and heat trap and expel the heat from the housing.

### BRIEF DESCRIPTION OF THE DRAWINGS

FIG. 1 is a side elevational view through one side of a housing showing the positioning of a fan and a reflector with a conical light and heat trap adjacent to an end of a fiber optic bundle, a color wheel is shown in a light path to the fiber optic bundle to change the color of the light directed to the end of the fiber optic bundle;

FIG. 2 is a cross sectional view taken on line 2-2 of FIG. 1 with parts removed for clarity showing the position of a lamp within the reflector and the position of the light and heat trap with a hot mirror adjacent to the end of the fiber optic bundle;

FIG. 3 is a plan view of a conical light and heat trap showing the direction of flow of air through the light and heat lamp; and

FIG. 4 is a side elevational view of the conical light and heat trap of FIG. 3.

### DETAILED DESCRIPTION OF THE PREFERRED EMBODIMENTS

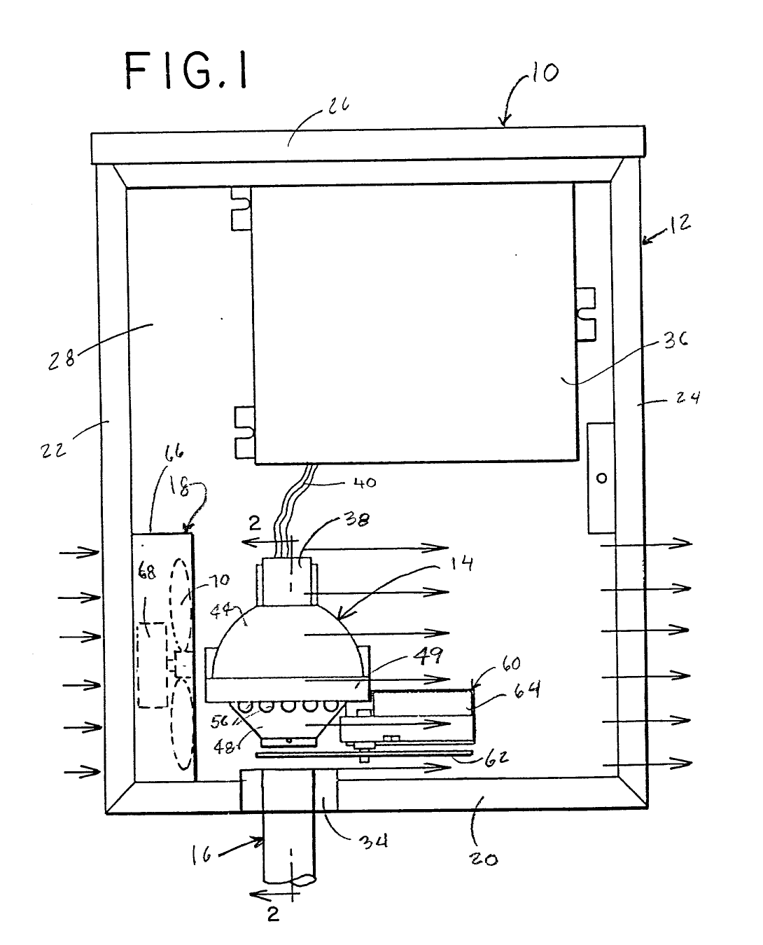

Referring now to the drawings and especially to FIG. 1, an apparatus to provide concentrated illumination to an end of a fiber optic bundle is shown therein and is generally indicated by numeral 10. Apparatus 10 generally includes a housing 12 with a light source assembly 14 mounted therein adjacent to one end of a fiber optic bundle 16. A fan assembly 18 is mounted in the housing to move air past and through the lighting assembly.

Housing 10 has a conventional construction including a floor 20 with a pair of end walls 22 and 24 secured to the floor perpendicular to the floor. A top 26 is connected to end walls 22 and 24. A back wall 28 is connected to the end walls 22 and 24 and the floor 20, as well as the top 26. A door is connected to the end walls 22 and 24 which door is of conventional construction and is not shown. End wall 22 has a conventional grilled inlet opening (not shown) and end wall 24 has a conventional grilled exhaust opening (not shown) aligned with the inlet opening.

Fiber optic bundle 16 is of a conventional construction which includes a plurality of conventional acrylic fibers 30 (however, glass fibers may be used) surrounded by and held together by a plastic coating or jacket 32. The fiber optic bundle has a collar 34 secured adjacent to one end. The collar with the fiber bundle is mounted in the floor of the housing, as may be seen in FIG. 1.

Light source assembly 14 includes an conventional electronic ballast 36 mounted on back wall 28. Ballast 36 is connected to a light socket 38 through conventional wires 40. Light socket 38 has a conventional lamp 42 mounted therein, which is a light source to emit light and heat including infrared and ultra-violet radiation. In this instance, the lamp is a 150W Ushio metal halide lamp, which when energized radiates visible light and heat including infrared radiation and ultra-violet radiation. though a specific lamp is identified above, a generally equivalent lamp may be used. A conventional reflector 44 having a conventional reflecting surface 46 is mounted adjacent to lamp 42. The reflector has the lamp positioned therein, so that substantially all of the radiation from the lamp is directed toward the end of the fiber optic bundle, as shown in FIG. 2.

A light and heat trap 48 is mounted adjacent to the open end of reflector 44 through nose bezel 49 to retain heat and redirect stray light in combination with the reflector. The light and heat trap is a truncated cone wherein the larger end of the cone is aligned with the open end of reflector 44. The smaller end of the cone has a hot mirror 50 mounted therein which is held in position by bracket 52. The conical trap has a polished interior conical surface 54 adjacent to the lamp, so that light striking interior surface 54 is reflected to the reflector to be directed toward the end of the fiber optic bundle. The trap has a plurality of ventilating apertures 56 extending therethrough, as shown in FIGS. 2, 3, and 4.

The center of the lamp is on a center line 58 which extends through the center of reflector 44l The center line extends through the center of the conical light and heat trap, as well as through the center of hot mirror 50. The center line also extends through the center of the end of the fiber optic bundle 16 as may be seen in FIG. 2. Thus, lamp 42 is aligned with the center of the reflector. The lamp is also aligned with the center of the light and heat trap, as well as the center of the hot mirror and the center of the end of the fiber optic bundle. The reflector 44 has its focal point below the end of the fiber optic bundle, so that all of the visible light passing through hot mirror 50 is delivered to the fiber optic bundle.

As is conventional, a portion of the light entering the fiber bundle is dissipated to the periphery of the fiber and the plastic coating 32, so that there is a sideglow created through the plastic coating for the sideglow fiber bundle. Light from lamp 42 is a white light. A color wheel assembly 60 has a portion of a color wheel 62 positioned between the hot mirror and the end of the fiber optic bundle, as may be seen in FIG. 1. The construction of the color wheel assembly is conventional, in that, color wheel 62 is rotated by a drive 64, which includes a conventional electric motor, not shown herein. As the color wheel 62 rotates, the colors on the color wheel determine the color of light which is impinged upon the fiber optic bundle, so that the light in the fiber optic bundle has a color which reflects the color of the portion of the color wheel, which is between the hot mirror and the end of the fiber optic bundle.

Hot mirror 50 is a conventional hot mirror, in that, it reflects both ultra-violet radiation, as well as infrared radiation. However, it allows visible light having a wavelength between 420 nm to 690 nm to pass through the mirror. The mirror reflects ultra-violet radiation having a wavelength to 390 nm and reflects infrared radiation having a wavelength in a range between 725 nm to 1550 nm. Substantially all of the ultra-violet radiation and infrared radiation is prevented from passing through the hot mirror and does not reach the fiber optic bundle, but rather contained within reflector 16 and light and heat trap 48.

Inasmuch as there is a decay of light energy at a rate which is the square of the distance between the light source and the target area of the light, it is desirable to place the light source as close to the end of the fiber optic bundle as possible. Heretofore, the prior art construction did not allow the light source to be particularly close to the end of the fiber optic bundle in view of the fact that the heat and the ultra-violet radiation produces a deleterious effect on the fiber optic fibers. Thus, it is desirable to place the lamp as close to the fiber optic bundle as possible, but without the deleterious effect created by heat and ultra-violet radiation.

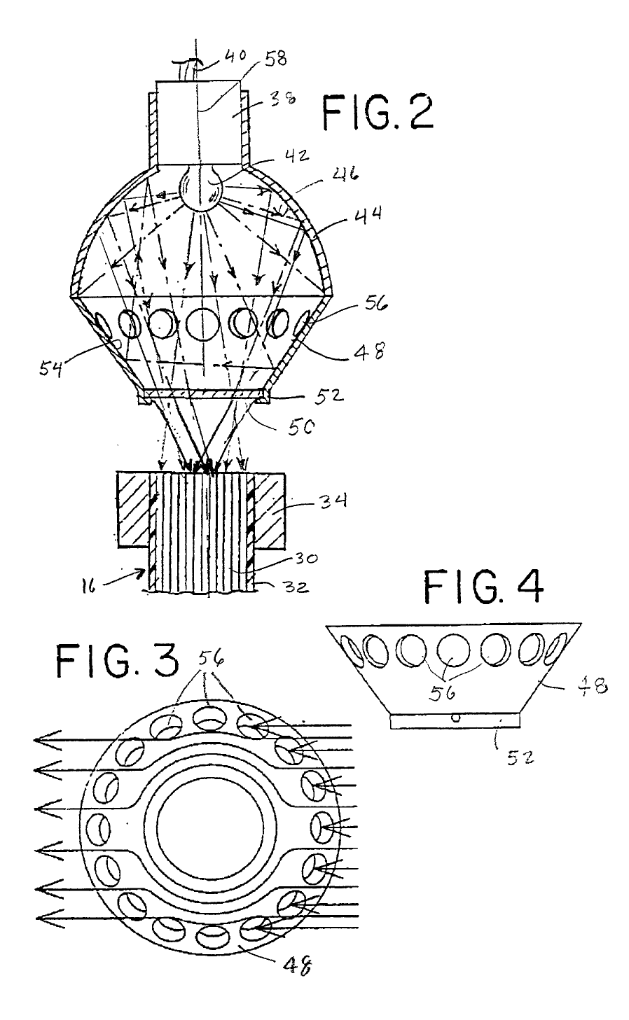

Heat generated by the lamp is removed from the enclosure formed by the reflector and the light and heat trap. Fan assembly 18 is mounted adjacent to the grilled inlet opening of wall 22. The fan assembly is a conventional air mover in its construction, in that, it includes a support housing 66 with a conventional drive motor 68 mounted therein. A conventional fan blade assembly 70 is drivingly connected to the motor 68 in order to draw air into housing 10 to flow over the reflector 44 and through and past light and heat trap 48 to be heated thereby. The heated air is expelled from the housing through the grilled exhaust opening of wall 24. The air driven by fan 70 enters the apertures 56 on one side of the trap, as shown in FIG. 3. The entering air pushes out the air which is within the trap and the reflector through the opposed apertures 56, as may be seen in FIG. 3. The flow of air through the trap removes the heat which is generated by lamp 42 to cool the interior of the trap. Lighting assembly 14 may be positioned closer to the end of the fiber optic bundle since the air moving past the reflector and the light and heat trap cools the reflector and the light and heat trap. Thus, the amount of light which is delivered to the end of the fiber optic bundle is improved by the square of the reduced distance.

The present construction provides an improvement, in that, the light and heat trap captures stray light which would normally not be delivered to the fiber optic bundle. The stray of light is reflected by polished reflecting surface 54 of the interior of the cone and is reflected back to the reflector to be directed toward the hot mirror and the end of the fiber optic bundle.

The instant construction provides an improved source of illumination, in that, the present construction allows the light source, that is, the lamp, to be closer to the end of the fiber optic bundle, and it conserves light, in that, stray light, which would ordinarily be dissipated, is captured and directed to the end of the fiber optic bundle.

Although a specific embodiment of the herein disclosed invention has been described in detail above, it is readily apparent that those skilled in the art may make various modifications and changes in the herein disclosed invention without departing from the spirit and scope of the invention. It is to be expressly understood that the instant invention is limited only by the appended claims.

What is claimed is:

1. A lighting apparatus to provide concentrated illumination to an end of a fiber optic bundle to produce useable light comprising; a light source emitting visible light and heat including infrared radiation and ultra-violet radiation, a reflector adjacent to the light source to direct light from the light source toward an end of the fiber optic bundle, a light and heat trap adjacent to the reflector for trapping heat and redirecting stray light in combination with the reflector toward the end of the fiber optic bundle, and a hot mirror positioned between the light and heat trap and the end of the fiber optic bundle to allow visible light to be transmitted through the mirror and to reflect infrared and ultra-violet radiation to prevent substantially all of the emitted infrared and ultra-violet radiation from reaching the fiber optic bundle.

2. A lighting apparatus to provide concentrated illumination to an end of a fiber optic bundle to produce useable light as defined in claim 1, wherein the light and heat trap has a conical polished reflecting surface adjacent to the light source.

3. A lighting apparatus to provide concentrated illumination to an end of a fiber optic bundle to produce useable light as defined in claim 1, wherein the light and heat trap has a plurality of apertures to allow air to leave the light and heat trap to carry away heat and to allow other air to replace the air leaving the trap to cool the interior of the light and heat trap.

4. A lighting apparatus to provide concentrated illumination to an end of a fiber optic bundle to produce useable light as defined in claim 1, including; an air mover moving air past the reflector and the light and heat trap to cool the reflector and the light and heat trap.

5. A lighting apparatus to provide concentrated illumination to an end of a fiber optic bundle to produce useable light as defined in claim 1, wherein the light and heat trap has a plurality of apertures to allow air to leave the light and heat trap to carry away heat and to allow other air to replace the air leaving the trap to cool the interior of the light and heat trap, said light and heat trap has a conical polished reflecting surface adjacent to the light source.

6. A lighting apparatus to provide concentrated illumination to an end of a fiber optic bundle to produce useable light as defined in claim 1, wherein the light and heat trap has a conical polished reflecting surface adjacent to the light source, and an air mover moving air past the reflector and the light and heat trap to cool the reflector and the light and heat trap.

7. A lighting apparatus to provide concentrated illumination to an end of a fiber optic bundle to produce useable light as defined in claim 1, wherein the light and heat trap has a plurality of apertures, an air mover moving air past the reflector and through the apertures of the light and heat trap to force air out of the light and heat trap to carry away heat and to move replacement air into the trap to cool the interior of the trap.

8. A lighting apparatus to provide concentrated illumination to an end of a fiber optic bundle to produce useable light as defined in claim 1, wherein the light and heat trap has a conical polished reflecting surface adjacent to the light source, said light and heat trap has a plurality of apertures, and an air mover moving air past the reflector and through the apertures in the light and heat trap to carry away heated air from the interior of the light trap and to replace the heated air to cool the interior of the light and heat trap.

9. A lighting apparatus to provide concentrated illumination to an end of a fiber optic bundle to produce useable light as defined in claim 1, wherein the apparatus has an apparatus centerline aligned with the center of the end of the fiber optic bundle, said light source having a center and the center being on the apparatus centerline, said reflector having a reflector centerline aligned with said apparatus centerline, said light and heat trap having a trap centerline aligned with the apparatus centerline, and said hot mirror having a mirror center on the apparatus centerline.

10. An apparatus for generating useable light in a fiber optic bundle comprising; a housing, an electronic ballast mounted in the housing, a light source connected to the electronic ballast, said light source mounted in the housing, said light source being adapted for emitting a range of energy including visible light and heat including infrared and ultra-violet radiation, a reflector positioned adjacent to the light source to direct light from the light source toward an end of the fiber optic bundle for generating light from the bundle, a light and heat trap adjacent to the reflector for retaining heat and redirecting stray light in combination with the reflector, and a hot mirror positioned between the light and heat trap and an end of fiber optic bundle to reflect infrared and ultra-violet radiation to prevent substantially all of the infrared and ultra-violet radiation from reaching the fiber optic bundle and to allow visible light to be transmitted through the mirror toward the fiber optic bundle.

11. An apparatus for generating useable light in a fiber optic bundle as defined in claim 10, wherein the light and heat trap is a truncated cone having a larger end is adjacent to the reflector and a smaller end is adjacent to the hot mirror.

12. An apparatus for generating useable light in a fiber optic bundle as defined in claim 10, wherein the light and heat trap has a conical polished reflecting surface adjacent to the light source.

13. An apparatus for generating useable light in a fiber optic bundle as defined in claim 10, wherein said light and heat trap has a plurality of apertures to allow air to leave the trap to carry away heat and to allow other air to replace the air leaving the trap to cool the interior of the light and heat trap, and an air mover moving air into the light and heat trap.

14. An apparatus for generating useable light in a fiber optic bundle as defined in claim 10, wherein the light and heat trap is a truncated cone, said truncated cone having a larger end adjacent to the reflector and a smaller end adjacent to the hot mirror, said truncated cone having a polished reflecting surface adjacent to the light source for redirecting stray light to the reflector to direct the stray light to the hot mirror.

15. An apparatus for generating useable light in a fiber optic bundle as defined in claim 10, wherein the light and heat trap is a truncated cone having a larger end adjacent to the reflector and a smaller end adjacent to the hot mirror, said light and heat trap has a polished interior surface to reflect light from the light source.

16. An apparatus for generating useable light in a fiber optic bundle as defined in claim 10, wherein the light and heat trap is a truncated cone having a larger end adjacent to the reflector and a smaller end adjacent to the hot mirror, said light and heat trap has an interior conical polished reflecting surface adjacent to the light source, said light and heat trap has a plurality of apertures, and an air mover moving air into the light and heat trap through the apertures to expel air from the interior of the light and heat trap to cool the interior of the light and heat trap.

17. An apparatus for generating useable light in a fiber optic bundle as defined in claim 10, wherein the light and heat trap is a truncated cone having a larger end adjacent to the reflector and a smaller end adjacent to the hot mirror, said truncated cone having a polished reflecting surface adjacent to the light source, said truncated cone having a plurality of apertures extending therethrough to allow air to leave the cone to carry away heat and allow replacement air to enter the cone to cool the interior of the cone, and an air mover moving air from outside the housing past the reflector and through the cone.
